(19) United States
(12) Patent Application Publication
(10) Pub. No.: US 2009/0307045 A1
(43) Pub. Date: Dec. 10, 2009

(54) SYSTEM AND METHOD FOR OPTIMIZATION OF MEETINGS BASED ON SUBJECT/PARTICIPANT RELATIONSHIPS

(75) Inventors: Al Chakra, Apex, NC (US); Melvin R. Jones, JR., Chapel Hill, NC (US); Julie A. Meserve, Raleigh, NC (US)

Correspondence Address: IBM RALEIGH IPLAW (DG);C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/136,618

(22) Filed: Jun. 10, 2008

(51) Int. Cl. G06Q 10/00; G06F 9/46

(52) U.S. Cl. 705/9

(57) ABSTRACT

In some embodiments, a method for determining meeting participants in an electronic calendar comprises identifying, based on user input, a first set of participants to invite to a meeting scheduled in the electronic calendar, wherein the meeting is associated with a topic. The method can also comprise identifying a second set of participants based on the topic associated with the meeting. The method can include determining a union of the first and second sets of participants and generating, for this union, calendar entries in the electronic calendar. The method can also include presenting the calendar entries in the electronic calendar.

### BACKGROUND

1. Technical field

Embodiments of the inventive subject matter generally relate to the field of calendar software, and more particularly, to techniques for optimizing meetings based on meeting subject and participant relationships.

2. Background

Users often use calendar software to schedule meetings. However, the software generally relies on users to efficiently enter meeting data and information about the meeting's participants. Typically, a calendar user contacts other meeting participants, determines their availability, and schedules the meeting. Some calendar software provides functionality limited to verifying whether the meeting participants are available at the proposed meeting time. Because using calendaring software typically requires human intervention, calendaring software often does not report important relationships and relevant data.

### SUMMARY

In some embodiments, a method for determining meeting participants in an electronic calendar comprises identifying, based on user input, a first set of participants to invite to a meeting scheduled in the electronic calendar, wherein the meeting is associated with a topic. The method can also comprise identifying a second set of participants based on the topic associated with the meeting. The method can include determining a union of the first and second sets of participants and generating, for this union, calendar entries in the electronic calendar. The method can also include presenting the calendar entries.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating a calendar system configured to determine candidate meeting participants, according to some embodiments of the invention.

FIG. 2 is a flow diagram illustrating operations for determining, based on rules, participants that should be part of a meeting, according to some embodiments of the invention.

FIG. 3 is a conceptual diagram illustrating screenshots associated with determining, based on rules, participants that should be invited to a meeting.

FIG. 4 is a flow diagram illustrating operations for determining alternate meeting schedules and/or meeting participants, according to some embodiments of the invention.

FIG. 5 is a conceptual diagram illustrating screenshots associated with determining alternate meeting participants and/or meeting schedules.

FIG. 6 is a block diagram illustrating a computer system configured to determine and present candidate meeting participants, according to some embodiments of the invention.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. In some instances, well-known instruction instances, protocols, structures, and techniques have not been shown in detail in order not to obfuscate the description.

### Introduction

Users typically use calendaring software that requires them to enter information about meeting participants. Typically, a user schedules meetings by contacting other meeting participants, determining their availability, and scheduling the meeting. Although some calendar software applications may verify that all the meeting participants are available at the proposed meeting time, most of the work of determining meeting participants and scheduling the meeting still requires human intervention. For example, the user scheduling a meeting may select meeting participants based on personal information about the meeting, information about the position of different participants in an organization, and knowledge about who has attended similar meetings in the past. However, because human interaction is involved, some important relationships between the meeting subject and prospective attendees may be overlooked. As a result, users may want a system that assists in the process of determining who should be invited to the meeting.

Some meetings may be scheduled months in advance. Before a meeting, employees may leave the organization, get promoted, or may become too busy to attend the meeting, so they may want another colleague to attend the meeting instead. Depending on the number and types of meetings scheduled, examining each meeting, rescheduling meetings, and/or sending meeting invitations to the appropriate people may be a daunting task. Hence, users may also want a system that automates the process of rescheduling and determining alternate meeting participants. Some embodiments of the inventive subject matter describe a rule based system which allows optimization of meetings based on relationships between meeting topics and meeting participants. The following discussion describes this and other important features in greater detail.

### Example Architecture and Operating Environment

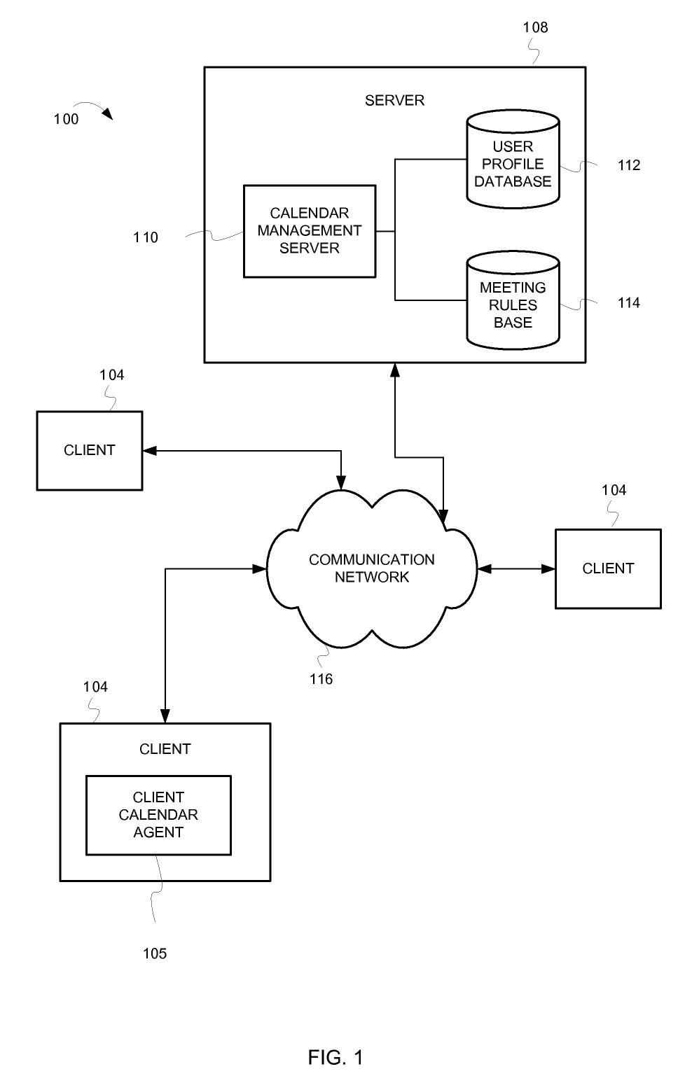

FIG. 1 is a block diagram illustrating a calendar system configured to determine meeting participants, according to some embodiments of the invention. As shown in FIG. 1, the system 100 includes a server 108 and clients 104. The server 108 includes a calendar management server 110, a user profile database 112, and a meeting rules base 114. The calendar management server 110 can include logic (e.g., software) for determining the appropriate meeting participants and transmitting this to a client calendar agent 105. The user profile database 112 can include information about users and other meeting participants. The information stored in the user profile database 112 can include the participants' official job description, project groups, positions in the organization, areas of expertise, and other such data. The meeting rules base 114 can include information about prospective participants in relation to other meeting participants, meeting topics, and/or other meeting keywords.

In one embodiment, the calendar management server 110 can examine meeting subjects and invited meeting participants, interface with the meeting rules base 114, and verify that all the key participants have been invited. For example, a user-specified rule in the meeting rules base 114 may state that a meeting topic keyword “software release planning” requires the participation of three key participants, their roles being: chief programmer, release manager, and project manager. The calendar management server 110 can interface with the user profile database 112, determine the participants who fit these roles, and propose inviting the required participants. In some instances, the calendar management server 110 can also highlight the lack of a participant, if it cannot find a participant fitting a “required role”.

In another embodiment, the calendar management server 110 can determine whether all the participants are available at the proposed meeting time. If meeting participants are unavailable (e.g., already booked for other meetings, on vacation, etc.), the calendar management server 110 can interface with the meeting rules base 114, determine whether the user has listed backup meeting participants, and send an invitation to the specified backup participants. In instances when no backups are listed, the calendar management server 110 can also interface with the user profile database 112 to suggest alternative meeting participants. For example, the server 110 can suggest alternate meeting participants by determining users with similar profiles, users holding the same position in the organization, users who are part of the same research group, etc. In some embodiments, the calendar management server 110 can go through the participants' calendar entries, determine available times, and suggest multiple alternate meeting dates and times when all the meeting participants are available. Thus, automating the process of rescheduling meetings and determining alternate meeting participants ensures that all key participants are present for the meeting. The calendar management server 109 can interface with the client calendar agent 105 to present alternate meeting participants and/or meeting schedules.

The server 108 and the clients 104 are connected to a communication network 116. The communication network 116 can include any technology suitable for passing communication between the clients and servers (e.g., Ethernet, 802.11n, SONET, etc.). Moreover, the communication network 116 can be part of other networks, such as cellular telephone networks, public-switched telephone networks (PSTN), cable television networks, etc. Additionally, the server 108 and clients 104 can be any suitable computing devices capable of executing software in accordance with the embodiments described herein.

### Example Calendar Management Operations

This section describes operations associated with some embodiments of the invention. The flow diagrams will be described with reference to the architectural block diagram presented above. However, in some embodiments, the operations can be performed by logic not described in the block diagrams; furthermore, some embodiments can perform more or less than the operations shown in any flow diagram. In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel.

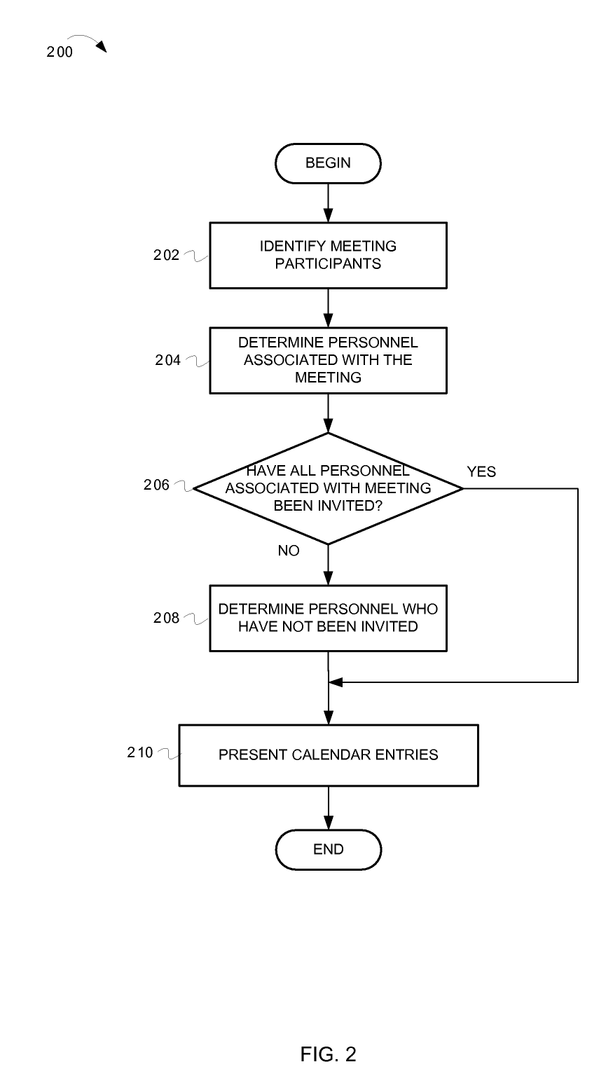

FIG. 2 is a flow diagram illustrating operations for determining, based on rules, participants that should be part of a meeting, according to some embodiments of the invention. The following discussion will describe the flow 200 with reference to the system of FIG. 1. The flow diagram 200 begins at block 202.

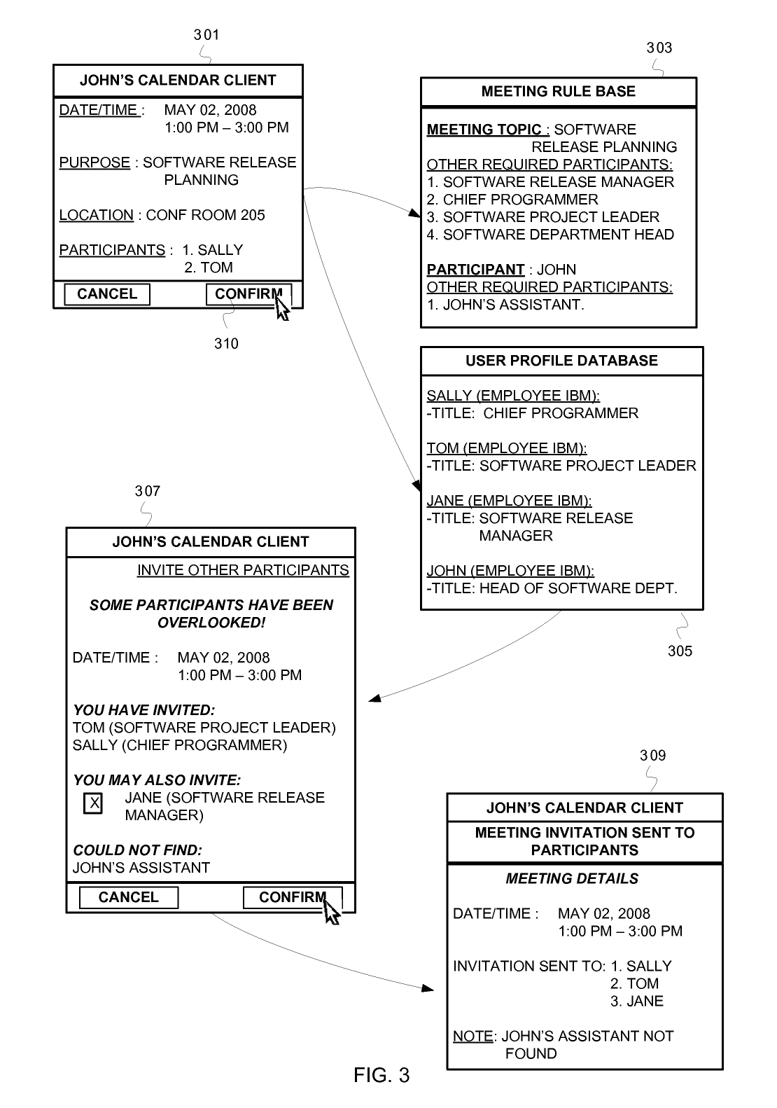

At block 202, the calendar management server 110 identifies the participants to a meeting scheduled using an electronic calendar. FIG. 3 helps illustrate this concept. In FIG. 3, a screenshot 301 shows an example calendar interface presenting meeting details including date, time, location, purpose of the meeting (meeting agenda), and meeting participants. In FIG. 3, the user (i.e., John) confirms the meeting by pressing the confirm button 310. After a meeting initiator confirms a meeting, a client calendar agent sends the meeting information (e.g., in an XML file) including the meeting date, time, participants, meeting topic, etc. to the calendar management server. In turn, the calendar management server 110 can determine whether all the users associated with the meeting have been invited. Referring back to FIG. 2, the flow continues at block 204.

At block 204, the calendar management server 110 determines personnel associated with the meeting. In some instances, the calendar management server 110 can interface with the meeting rules base 114 and determine which users should be invited to the meeting. The policies in the meeting rules base 114 can be based on the meeting topic, the meeting initiator, other participants involved in the meeting, meeting keywords, etc. In FIG. 3, the meeting rules base 303 includes policies based on the meeting topic (e.g., software release planning). For example, the rules dictate that, if the user initiates a meeting for software release planning, the software release manager, the chief programmer, the software project leader, and the software department's head must all be present. Similarly, policies can also be configured based on meeting participants. For example, the meeting rules base 303 includes a rule which dictates that whenever John is invited to a meeting, his assistant must also be invited. Additionally, the calendar management server can also interface with a user profile database, determine who the actual participants are and what their roles are, and ensure that all the required participants are invited to the meeting. Referring back to FIG. 2, the flow continues at block 206.

At block 206, the calendar management server 110 determines whether all the personnel associated with the meeting have been invited. The calendar management server 110 can compare meeting participants (received from the client calendar agent 105) with a list of participants that must be invited to the meeting (as determined by checking the meeting rules base 114 and the user profile database 112) and determine whether all the participants have been invited to the meeting. Block 305 in FIG. 3 shows an example user profile database which includes names and positions of various employees in an organization. In this example, by comparing the meeting rules in the meeting rules base with the profiles in the user profile database, the calendar management server can determine that John must invite his assistant, Sally (chief programmer), Tom (software project leader), and Jane (software release manager) to the proposed meeting. Referring back to FIG. 2, the flow continues at block 208.

At block 208, the calendar management server 110 determines personnel who have not been invited to the meeting. In FIG. 3, the calendar management server indicates, via the client calendar agent, that the software release manager (i.e., Jane) is a required participant that has not been invited to the meeting. In some instances, the calendar management server can propose inviting the required participant (e.g., Jane), as shown in screenshot 307. In some instances, if the calendar management server is unable to find a participant matching a specified role, it can highlight the lack of a participant. In screenshot 307, the calendar management server informs the meeting initiator (i.e., John) that it cannot find a participant matching the profile description “John's assistant”. In some instances, the calendar management server can also propose the exclusion of unnecessary participants. Referring back to FIG. 2, after the calendar management server 110 recommends inviting the required participants, the flow continues at block 210.

At block 210, the calendar management server 110 interfaces with the client calendar agent 105 to present calendar entries. In FIG. 3, the screenshot 309 shows an interface presented on a user's client calendar agent. Referring back to FIG. 2, after the user confirms the meeting details, the flow ends.

Using the client calendar agent 105, users can configure the calendar management server 110 to check for meeting updates, check for modifications to the user profile database 112 and the meeting rules base 114, send meeting reminders, etc. For example, if the meeting topic changes, different meeting participants may be required to attend the meeting. In some instances, the meeting rules base 114 and the user profile database 112 can be updated independent of the calendar (e.g., personnel changes, role changes, meeting rule changes, etc). The calendar management server 110 can be configured to examine scheduled meetings, determine changes in meeting details, and present modified meeting details on the client calendar agent 105 at regular intervals. The calendar management server 110 can send the modified meeting schedule in an invitation to the other participants after the meeting is confirmed.

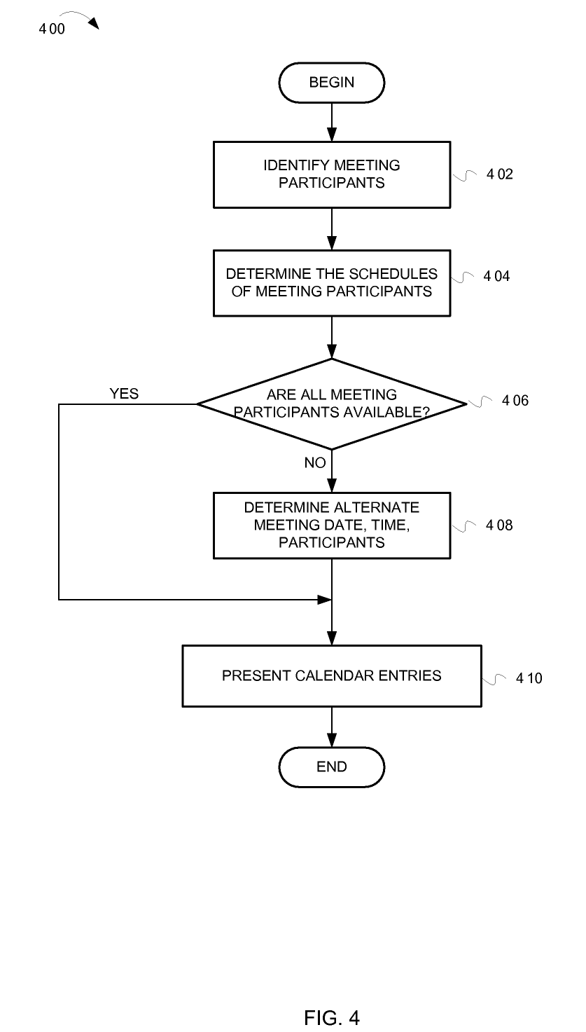

FIG. 4 is a flow diagram illustrating operations for determining alternate meeting schedules and/or meeting participants, according to some embodiments of the invention. The following discussion will describe the flow 400 with reference to the system of FIG. 1. The flow diagram 400 begins at block 402.

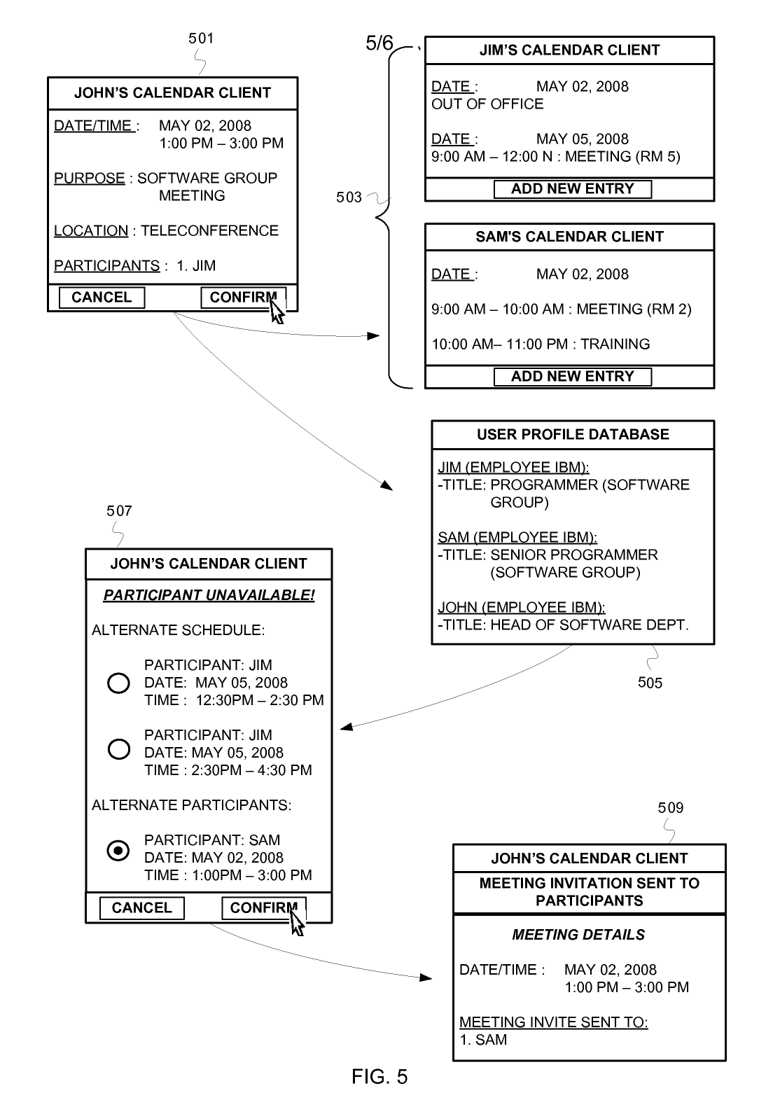

At block 402, the calendar management server 110 identifies the participants to a scheduled meeting using an electronic calendar. As described earlier, after a meeting initiator confirms a meeting, a client calendar agent 105 sends the meeting information (e.g., in an XML file) including the meeting date, time, participants, meeting topic, etc. to the calendar management server 110. FIG. 5 helps illustrate this concept. In FIG. 5, screenshot 501 shows an example interface presenting meeting details including date, time, location, purpose of the meeting, and meeting participants. In FIG. 5, the user (i.e., John) confirms the meeting by pressing the confirm button. Referring back to FIG. 4, the flow continues at block 404.

At block 404, the calendar management server 110 determines the meeting participants' schedules. In some instances, the calendar management server 110 can interface with other calendaring systems used by meeting participants to determine their schedules. The calendar management server 110 can determine when the meeting participants are available, and in some instances, it can also temporarily store this information (e.g., in a local cache). In FIG. 5, the calendar management server may interface with the participant's calendar 503 (i.e., Jim's calendar) to determine his schedule (e.g., Jim is on leave). Referring back to FIG. 4, the flow continues at block 406.

At block 406, the calendar management server 110 determines whether all the meeting participants are available. The calendar management server 110 can perform either a perfunctory search to determine if all participants are available at the proposed meeting time or a more exhaustive search to determine the participants' availability over a longer time range (e.g., two weeks, a month, etc). For example, in FIG. 5, the calendar management server can determine that Jim is unavailable on the 2^{nd} of May and will be available only from the 5^{th} of May. Referring back to FIG. 4, if the calendar management server 110 determines that all the meeting participants are available, the flow continues at block 410. Otherwise, the flow continues at block 408, where the calendar management server 110 can either reschedule the meeting or suggest alternate meeting participants.

At block 408, the calendar management server 110 determines alternate meeting participants and/or meeting dates and times. The calendar management server 110 can interface with the user profile database 112 to determine alternate participants with the same job title, similar job description, with the same expertise, belonging to the same research group, etc. In some instances, the meeting participants may have the option of listing one or more backup meeting participants in the meeting rules base 114. Thus, if the meeting participant is unavailable (e.g., attending other meetings, on vacation, etc.), the calendar management server 110 can interface with the meeting rules base 114, determine whether the user has listed backup meeting participants, and send an invitation to the specified backup participants. In FIG. 5, a client calendar agent can present a screenshot 507. In screenshot 507, John's client calendar agent presents alternate meeting schedules and meeting participants. The calendar management server can determine that the intended participant (Jim) is unavailable, search through the user profile database, (see 505) determine that Sam is an appropriate alternate meeting participant, determine that Sam is available at the proposed meeting time (see 503), and present this information on John's client calendar agent (see 507). The calendar management server can also determine that Jim will be available on the 5^{th} of May and present an alternate meeting schedule. The meeting initiator (John) can choose one of the options and confirm the meeting. Referring back to FIG. 4, after the calendar management server 110 determines and presents alternate meeting participants and/or schedules, the flow continues at block 410.

At block 410, the calendar management server 110 interfaces with the client calendar agent 105 to present calendar entries. In FIG. 5, the screenshot 509 shows an interface presented on a user's client calendar agent. The calendar management server can send the modified meeting schedule in an invitation to the other participants after the meeting is confirmed. Referring back to FIG. 4, after the user confirms the meeting details, the flow ends.

### Example Server Architecture

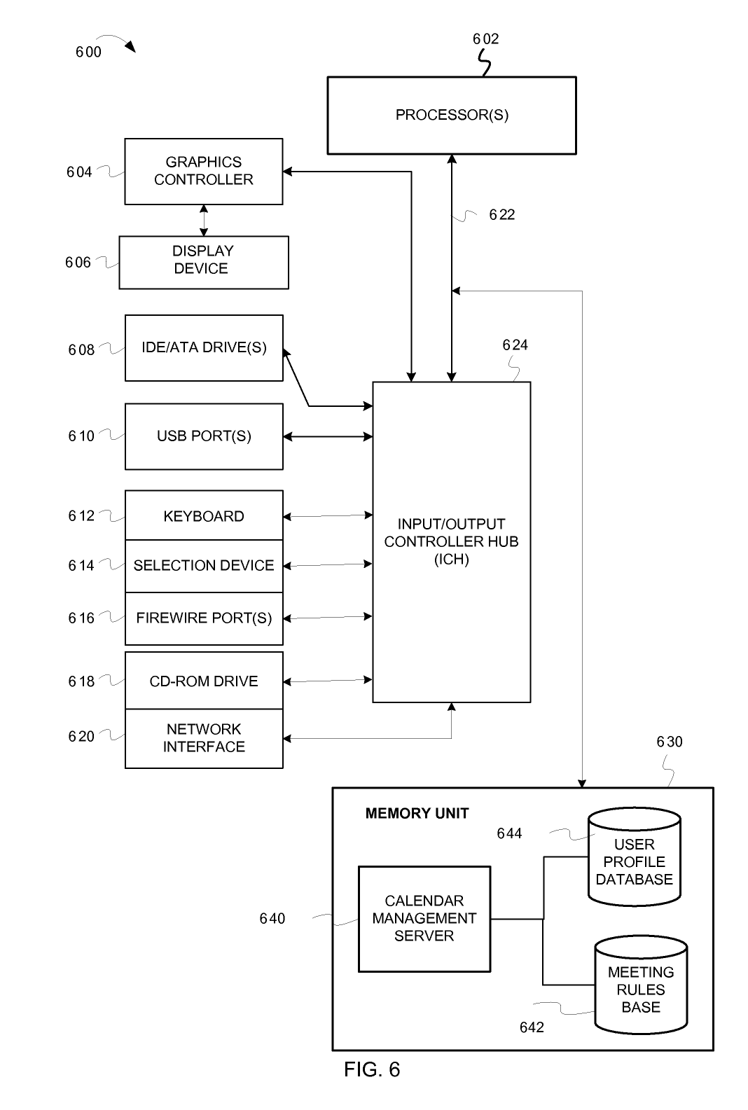

FIG. 6 is a block diagram illustrating a computer system configured to determine and present candidate meeting participants, according to some embodiments of the invention. The computer system 600 can be configured to operate similar to the server shown in FIG. 1.

The computer system 600 includes a processor 602. The processor 602 is connected to an input/output controller hub 624 (ICH) also known as a south bridge. A memory unit 630 interfaces with the processor 602 and the ICH 624. The main memory unit 630 can include any suitable random access memory (RAM), such as static RAM, dynamic RAM, synchronous dynamic RAM, extended data output RAM, etc.

In one embodiment, the memory unit 630 includes a calendar management server 640, a user profile database 644, and a meeting rules base 642. The calendar management server 640 can include logic (e.g., software) for determining and presenting the appropriate meeting participants on a client's calendaring system (not shown). The user profile database 644 can include information about the users and other meeting participants. The information stored in the database 644 can include the participants' official job description, project groups that the participant is a part of, position in the organization, etc. The meeting rules base 642 can include information about candidate participants in relation to the other meeting participants, keywords, and/or the meeting topic. In some embodiments, the calendar management server 640 can examine meeting details (e.g., meeting topic, participants, etc.) and interface with the meeting rules base 642 and the user profile database 644 to ensure that all the key participants have been invited to the meeting. In some instances, the calendar management server 640 can also propose alternate meeting participants and/or meeting schedules if one or more of the meeting participants are unavailable.

The ICH 624 connects and controls peripheral devices. In FIG. 6, the ICH 624 is connected to IDE/ATA drives 608 (used to connect external storage devices) and to universal serial bus (USB) ports 640. The ICH 624 may also be connected to a keyboard 612, a selection device 614, firewire ports 616 (for use with video equipment), CD-ROM drive 618, and a network interface 620. The ICH 624 can also be connected to a graphics controller 604. The graphics controller is connected to a display device (e.g., monitor).

In some embodiments, the computer system 600 can include additional devices and/or more than one of each component shown in FIG. 6 (e.g., video cards, audio cards, peripheral devices, etc.). For example, in some instances, the computer system 600 may include multiple processors, multiple cores, multiple external CPU's. In other instances, components may even be integrated or subdivided. In addition, embodiments may be embodied in an electrical, optical, acoustical or other form of propagated signal (e.g., carrier waves, infrared signals, digital signals, etc.), or wireline, wireless, or other communications medium.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language (e.g., Java, Smalltalk, C++, etc.) and conventional procedural programming languages (e.g., “C” programming language, etc). The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

### Conclusion

While the embodiments are described with reference to various implementations and exploitations, it will be understood that these embodiments are illustrative and that the scope of the inventive subject matter is not limited to them. In general, techniques for optimizing meetings based on meeting subject and participant relationships are described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for determining meeting participants in an electronic calendar, the method comprising:
identifying, based on user input, a first set of participants to invite to a meeting scheduled in the electronic calendar, wherein the meeting is associated with a topic;
identifying a second set of participants based on the topic associated with the meeting;
determining a union of the first and second sets of participants;
generating, for the union of the first and second sets of participants, calendar entries in the electronic calendar; and
presenting the calendar entries in the electronic calendar.

2. The method of claim 1 further comprising:
determining, based on scheduling information in the electronic calendar, that at least one of the participants has a scheduling conflict;
determining, based on participant profile information associated with the electronic calendar, one or more alternate participants for the meeting; and
presenting the one or more alternate meeting participants.

3. The method of claim 1, wherein determining relevant candidate participants is based on user-defined meeting rules, wherein the meeting rules are stored in a meeting rules database associated with the electronic calendar.

4. The method of claim 1, wherein the meeting rules can be associated with any one or more of the meeting topic, meeting participants, and meeting keywords.

5. The method of claim 1, wherein the user's profile information includes any one or more of participants' official job description, project groups that the participant is a part of, position in the organization, areas of expertise, and information from electronic business cards.

6. The method of claim 1, wherein the calendar entries are updated in response to a request by one of the participants, wherein the updating occurs at one or more of when a meeting invitation is sent, on the day of the meeting, and periodically at a regular interval.

7. The method of claim 1, wherein the updating occurs in response to a modification in one or more of the meeting rules, the personnel changes, the user profile information, and the meeting details.

8. An apparatus for determining meeting participants in an electronic calendar, the apparatus comprising:
a client calendar application configured to present meeting schedules and participant related data feeds;
a user profile database including information about the meeting participants;
a meeting rule base including relationships between prospective participants and meeting details; and
a calendar management server electronically coupled to the user profile database, the meeting rule base, and the client calendar application, the calendar management server configured to
identify, based on user input, a first set of participants to invite to a meeting scheduled in the electronic calendar, wherein the meeting is associated with a topic,
identify a second set of participants based on the topic, the user profile database's information about the meeting participants, and the meeting rule base's relationships,
determine a union of the first and second sets of participants,
generate, for the union of the first and second sets of participants, calendar entries in the electronic calendar, and p2 present the calendar entries in the electronic calendar.

9. The apparatus of claim 8, wherein the calendar management agent is further configured to
determine, based on scheduling information in the electronic calendar, that at least one of the participants has a scheduling conflict,
determine, based on participant profile information associated with the electronic calendar, one or more alternate participants for the meeting, and present the one or more alternate meeting participants.

10. The apparatus of claim 8, wherein determining relevant candidate participants is based on user-defined meeting rules, wherein the meeting rules are stored in a meeting rules database associated with the electronic calendar, and wherein the meeting rules can be associated with any one or more of the meeting topic, meeting participants, and meeting keywords.

11. The apparatus of claim 8, wherein the user's profile information includes any one or more of participants' official job description, project groups that the participant is a part of, position in the organization, areas of expertise, and information from electronic business cards.

12. The apparatus of claim 8, wherein the calendar entries are updated in response to a request by one of the participants, wherein the updating occurs at one or more of when a meeting invitation is sent, on the day of the meeting, and periodically at a regular interval.

13. The apparatus of claim 8, wherein the updating occurs in response to a modification in one or more of the meeting rules, the personnel changes, the user profile information, and the meeting details.

14. One or more machine-readable media having stored therein a program product, which when executed a set of one or more processor units causes the set of one or more processor units to perform operations for determining meeting participants in an electronic calendar, the operations comprising:
identifying, based on user input, a first set of participants to invite to a meeting scheduled in the electronic calendar, wherein the meeting is associated with a topic;
identifying a second set of participants based on the topic associated with the meeting;
determining a union of the first and second sets of participants;
generating, for the union of the first and second sets of participants, calendar entries in the electronic calendar;
presenting the calendar entries in the electronic calendar;

15. The one or more machine-readable media of claim 14 further comprising:
determining, based on scheduling information in the electronic calendar, that at least one of the participants has a scheduling conflict;
determining, based on participant profile information associated with the electronic calendar, one or more alternate participants for the meeting; and
presenting the one or more alternate meeting participants.

16. The one or more machine-readable media of claim 14, wherein determining relevant candidate participants is based on user-defined meeting rules, wherein the meeting rules are stored in a meeting rules database associated with the electronic calendar.

17. The one or more machine-readable media of claim 14, wherein the meeting rules can be associated with any one or more of the meeting topic, meeting participants, and meeting keywords.

18. The one or more machine-readable media of claim 14, wherein the user's profile information includes any one or more of participants' official job description, project groups that the participant is a part of, position in the organization, areas of expertise, and information from electronic business cards.

19. The one or more machine-readable media of claim 14, wherein the calendar entries are updated in response to a request by one of the participants, wherein the updating occurs at one or more of when a meeting invitation is sent, on the day of the meeting, and periodically at a regular interval.

20. The one or more machine-readable media of claim 14, wherein the updating occurs in response to a modification in one or more of the meeting rules, the personnel changes, the user profile information, and the meeting details.
